(19) United States
(12) Patent Application Publication
(10) Pub. No.: US 2018/0090005 A1
(43) Pub. Date: Mar. 29, 2018

(54) Method And Apparatus For Vulnerable Road User Incidence Avoidance

(71) Applicant: GM GLOBAL TECHNOLOGY OPERATIONS LLC, Detroit, MI (US)

(72) Inventors: Tal Philosof, Givatayim (IL); Eilon Riess, Zikron-Yaakov (IL); Omer Tsimhoni, Bloomfield Hills, MI (US); Claudia V. Goldman-Shenhar, Mevasseret Zion (IL); Yael Shmueli Friedland, Tel AVIV (IL)

(21) Appl. No.: 15/277,083

(22) Filed: Sep. 27, 2016

(51) Int. Cl. G08G 1/16

(52) U.S. Cl. CPC G08G 1/163; H04L 67/12; G08G 1/166

(57) ABSTRACT

The present application generally relates communications and hazard avoidance within a monitored driving environment. More specifically, the application teaches a mechanism to monitor, identify and locating vulnerable road users in a hazard situation by receiving location and vector information from road users in an environment, determining the probability of a hazard situation arising in response to the location and vector information, and transmitting data to one or more road users in order to avoid the hazard situation.

### BACKGROUND OF THE INVENTION

### Field of the Invention

The present application generally relates communications and hazard avoidance within a monitored driving environment. More specifically, the application teaches a mechanism to monitor, identify and locating vulnerable road users in a hazard situation by receiving location and vector information from road users in an environment, determining the probability of a hazard situation arising in response to the location and vector information, transmitting data to one or more road users in order to avoid the hazard situation, and/or determining a evasive action to avoid the hazard situation.

### Background Information

Certain vehicles today utilize connectivity to improve safety in the vehicle. The vehicle may be autonomous, semi-autonomous, or a traditional driver controlled vehicle. In addition, other vulnerable road users, such as pedestrians or cyclists are present around these vehicles. It would be desirable to warn both vehicle and vulnerable road user about possible hazard situations.

Accordingly, it is desirable to provide improved techniques for hazard warning systems in vehicles and vulnerable road users, for example, improving situational awareness in low visibility situations. It is also desirable to provide methods, systems, and vehicles utilizing such techniques. Furthermore, other desirable features and characteristics of the present invention will be apparent from the subsequent detailed description and the appended claims, taken in conjunction with the accompanying drawings and the foregoing technical field and background.

### SUMMARY OF THE INVENTION

In accordance with an aspect of the present invention, an apparatus for a receiver for receiving a first data indicating a first location and a first vector of a first road user and a second data indicating a second location and a second vector of a second road user, a processor for determining a hazard situation in response to the first data and the second data, and a transmitter for transmitting a third data to said first road user wherein said third data indicates a third vector, the transmitter further operative to transmit a fourth data to said second road user wherein said fourth data indicates a fourth vector.

In accordance with another aspect of the present invention, a method for receiving a first data indicating a first location and a first vector of a first road user, receiving a second data indicating a second location and a second vector of a second road user, determining a hazard situation in response to the first data and the second data, transmitting a third data to said first road user wherein said third data indicates a third vector, and transmitting a fourth data to said second road user wherein said fourth data indicates a fourth vector.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram showing an exemplary environment for implementing the present disclosed systems and methods;

FIG. 2 is a block diagram illustrating an exemplary implementation of an apparatus for vulnerable road user incidence avoidance.

FIG. 3 is a flow chart illustrating an exemplary implementation of a method for vulnerable road user incidence avoidance.

FIG. 4 shows a flowchart illustrating a method 400 information processing in a system for incident avoidance for vulnerable road users.

FIG. 5A shows a block diagram illustrating an exemplary implementation of an apparatus according for vulnerable road user incidence avoidance.

FIG. 5B shows a block diagram illustrating an exemplary implementation of an apparatus according for vulnerable road user incidence avoidance.

FIG. 5C shows a block diagram illustrating an exemplary implementation of an apparatus according for vulnerable road user incidence avoidance.

FIG. 5D shows a block diagram illustrating an exemplary implementation of an apparatus according for vulnerable road user incidence avoidance.

FIG. 5E shows a block diagram illustrating an exemplary implementation of an apparatus according for vulnerable road user incidence avoidance.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

The present application teaches a method and system for to monitor, identify and locating vulnerable road users (VRUs) that are in risk of a hazard situation in an environment proximate to a vehicle. This system is based on vehicle to mobile, vehicle to vehicle, mobile to vehicle and/or mobile to mobile unit communication, which may also include Vehicle-to-Pedestrian (V2P) communication. Communication may be made through a wireless network, such as cellular, 4G, or 5G, or other communications protocol wherein the network may include a server for receiving data on vehicles, road users, environmental aspects and physical aspects of the environment proximate to the road users. When VRU is in a hazard situation in close vicinity to the vehicle, the driver and the VRU may get a notification for this hazard. VRUs may include Pedestrian, Motorcycles, Bicycles, Rollerblades, and any future transportation that might hurt from vehicles

The system may include a driving assisted mechanism for monitoring, identifying, and detecting vulnerable road users such as pedestrians, rollerblade, bike and motorcycle, or the like and for identifying the position, velocity, direction and relative distance between users using technology such as WiFi, UWB, or radar or other wireless communications method. In non-autonomous vehicles or non vehicles, the method and system according to the present application may be used to help an operator to identify and detect vulnerable pedestrian, bikers and motorcyclist. The system may further be operative to identify unpredictable pedestrian or cyclist behavior and to avoid a hazard situation before it becomes evident to a vehicle user.

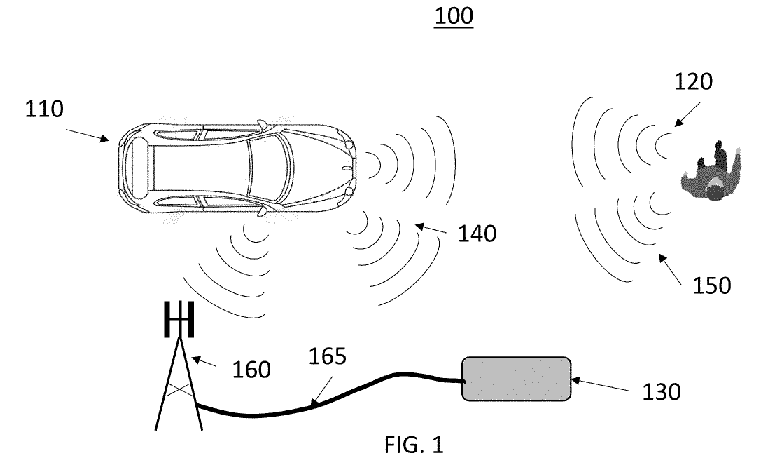

Referring now to the drawings, and more particularly to FIG. 1, a diagram of an exemplary embodiment 100 of an environment for vulnerable road user incidence avoidance is shown. The vehicle 110 is equipped with a wireless communication device to transmit and receive electromagnetic waves 140. The radar system or other sensor system, such as LIDAR, optical, etc., is used to locate objects proximate to the vehicle in order for the systems within the vehicle to control the vehicle in light of the located objects. Sharing the road may be vulnerable road users (VRU) 120 who may also have wireless communication devices useful for the system of the present application. The VRU wireless device also transmits and receives wireless information 150. There may also be a central processor 130 coupled to the various wireless and wired networks for implementing the system and method of the present application.

In a first exemplary embodiment, the processing determination of the hazard situation is performed in a centralized manner. The central processor 130 is operative to receive location and direction information form road users, including the vehicle 110 and the VRU 120. The central processor 130 may further be operative to receive environmental information, such as maps, weather, emergency alerts and the like via wireless and wired network connections. The central processor 130 may user any or all of this information to detect possible hazard situations. A hazard situation may include possible collisions, or low visibility conditions which limit the effectiveness of radar, lidar, or other onboard sensor systems. The central processor 130 may then transmit a warning to both the vehicle 110 and the VRU 120 indicating the hazard situation. Further, the central processor 130 may be operative to transmit directional instructions that may be used for avoiding the hazard situation. For example, in the possible event of a collision, the central processor 130 may transmit to the VRU to stop moving and may transmit to the vehicle 110 to reduce speed and to change direction. In another example, the central processor 130 made transmit a control signal to the vehicle 110 to control the vehicle, such as stopping, without driver interaction. The central processor 130 may be in communication 165 with the vehicle 110 and/or the VRU 120 via a cellular network 160. The system may deliver messages between all road users (vehicles, pedestrians, etc.). The messages can include time stamp, location, speed, acceleration, radial speed, radial acceleration, heading direction, and the like. The messages may be delivered from each unit in periodic manner, so all users (vehicle, pedestrian) or the network side (in case of centralized computing) have the data to identify VRUs in risk

In a second exemplary embodiment, the processing determination of the hazard situation is performed in a distributed manner. Communications can be made either directly between VRUs 120 and/or vehicles 110 or via a cellular network 160 which is used as an infrastructure, such as a road side unit, between VRUs 120 and/or vehicles 110. In this embodiment, the processor is performed on the user side. Each user may transmit and receive information from other users, and the user then determines the possibility of a hazard situation. Once a hazard situation is determined, the user may transmit a data to the other users, and/or determine a control response to avoid the hazard situation. Alternatively, some of the processing may be made by the central processor 130 and some of the processing done by the users in either a peer to peer manner or a distributed manner.

Communication between vehicles 110 and VRUs 120 within the system may be made using any combination of the above embodiments. For example, data may be transmitted by a VRU to a vehicle and then the vehicle transmits the data via a cellular or 801.11p (DSCR) network to a central processor 130. Communications architecture may include vehicle/VRU communication over a cellular network using 4G or 5G. Communications may be performed over a Dedicated Short Range Communications (DSRC) network. DSRC is a two-way short- to -medium-range wireless communications capability that permits very high data transmission critical in communications-based active safety applications. The system architecture may include a network computing architecture where a centralized cloud computing configuration is utilized to facilitate communication of data over a cellular network to a central processor 130. Alternatively, a system architecture may include direct radio frequency communications between vehicles and/or VRUs. In this architecture, determination of hazard situations may be performed on a peer to peer or distributed basis directly by the users. A system architecture employing vehicle computing and communication of cellular and direct communication or network computing and communication over cellular and direct communication.

In addition, the VRU 120 may be able to monitor transmission directly from a vehicle 110 via a mobile device or the like. The VRU 120 may use this information to determine the direction and velocity of a vehicle 110 and determine that a hazard situation may arise. The mobile device may then be configured to actuate a warning to the VRU 120 alerting them to the possible hazard situation, allowing the VRU time to avoid the hazard situation.

In determining hazards situations, the system may be operative to first define a region of interest (ROI). A vehicle ROI may be defined based on its location (X, Y, Z), speed (Vx, Vy, Vz) and its acceleration (Ax, Ay and Az). A pedestrian or VRU ROI may be defined based on its location (X, Y, Z), speed (Vx, Vy, Vz) and its acceleration (Ax, Ay and Az). Several events may alert the system to a possible hazard situation, including the instance when there is a pedestrian (X, Y, X location) in vehicle ROI, there is an unexpected VRU in a vehicle ROI, when a vehicle 110 exceeds a velocity threshold, when a VRU exceeds a velocity threshold, when a vehicle 110 or VRU exceeds an acceleration threshold, when a VRU or vehicle initiates an indication of a hazard situation, or in the instance of a vehicle or VRU response to a acknowledgement between a vehicle and VRU. The system may be further operative to determine expected paths of vehicles and VRUs based on Kinematics, GPS data, gyroscope, compass accelerometers, user inputs and data from other onboard sensors.

Adaptive thresholds may be determines with updates for V2P warning and detection algorithm, based on user self-definition, such as children operating low speed devices such as scooters or bikes, adults with disability or dynamic user data or messages between vehicles and VRUs. Enhanced vehicle to VRU communications may be used for autonomous vehicle situations to implement enhanced communications and actions between autonomous vehicles and pedestrians.

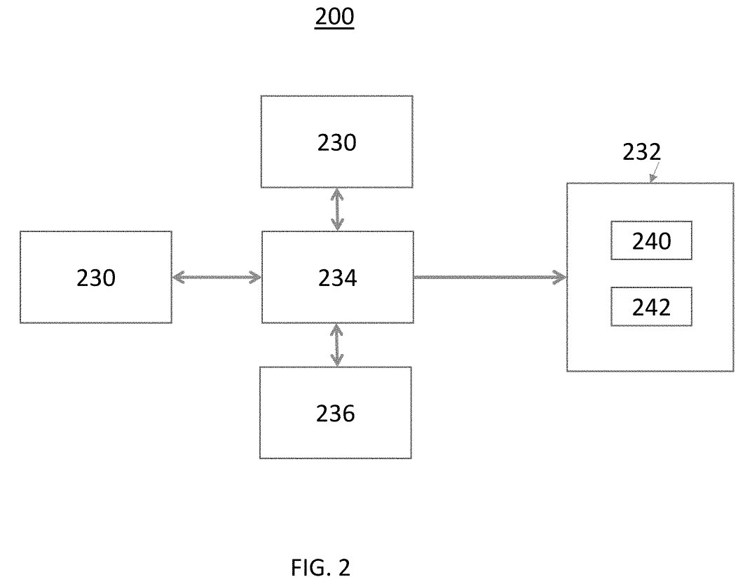

Turning now to FIG. 2 a block diagram illustrating an exemplary implementation of an apparatus 200 according for vulnerable road user incidence avoidance is shown. Central to the system is a processor 234 for processing a data received from a road user. This data may include a location and a vector indication the speed and direction of the road user. The processor may receive data from a number of vehicles, road users, or devices proximate to road user, such as mobile devices. The processor is then operative to examine the data and determine if a hazard condition may exist. This determination may include examining the location and vectors of two road users and determining if a collision is likely. Other hazard conditions may involve determining that a road user is driving in a manner that exceeds a safety threshold with respect to the weather conditions. If the processor determines that a hazard condition exists, a third data is generated indicating information which may be used by a road user in order to avoid the hazard condition.

The apparatus also includes a receiver 230 for receiving the data from a road user. The receiver 230 may be operative to receive data from a plurality of road users. Additionally the apparatus includes a transmitter 236 for transmitting data to a road user indicating the presence of a hazard conditions and instructions or data for avoiding the hazard condition. This transmitter may be operative to transmit data to a plurality of road users.

The system may further comprise a sensor suite 232 for detecting hazard conditions. The system may include radar 240 and a global positioning sensor (GPS) 242. The sensor suite 232 would be present in an example when the processor 234 is onboard with the road user. The sensor suite may not be present if the processor 234 is located at a central or remote location to the road users.

The apparatus may further include an alert system 230 responsive to the control signal generated by the processor 234. The alert system may be carried by the road user and may be used for warning another road user of a hazard condition. The alert system may generate an alert toward the location of another road user, where the alert may be a directional light, such as a spotlight or the like, and/or an audible alarm. For example, if the road user is a vehicle, the vehicle may be equipped with a rotational spotlight and loudspeaker. If a hazard condition is determined, the rotational spotlight may be rotated to point at the other road user, such as a pedestrian, and the audible alert played over the loudspeaker. This would have the effect of altering the other road user to the presence of the vehicle and the possibility of a collision or the like.

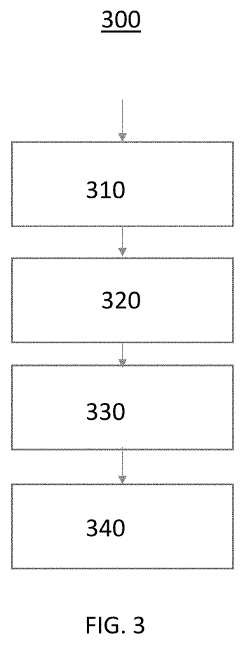

Turning now to FIG. 3, a flowchart illustrating a method 300 for incident avoidance for vulnerable road users according to an exemplary embodiment of the present application is shown. The system is operative to monitor data transmitted from road users in an effort to avoid a hazard event. The system is first operative to receive a first data indicating a first location and a first vector of a first road user 310. The data may be received via a cellular network or the like. The data may also be transmitted to a local receiver, such as a receiver situated on a road side unit, such as a building or light post, and then transmitted to the central processor via a wired network or any combination thereof. The data may consist of location data of the road user, directional information, speed, acceleration, location history and the like. The system is then operative to receive a second data indicating a second location and a second vector of a second road user 320. This data may be from a vulnerable road user and include the location data of the road user, directional information, speed, acceleration, location history and the like. The system is then operative to analyze this first data and second data and to predict the likelihood of a hazard situation occurring 330. Once a likelihood of a hazard situation is determined, the system is operative to transmit data to at least one of the road users indicating the possibility of the hazard situation 340. The system may be operative to transmit control data to at least one of the road users in order to control the vehicle to avoid the hazard incident. The control information may include, for example, a control signal to reduce the speed of a vehicle or to stop the vehicle. The control information may alternatively include information to be used by a human user, such as an indication of a hazard situation and a instruction such as “vehicle approaching from your rear, take precautions.” The system may further take into account geographical or environmental data when determining a hazard situation. For example, the system may determine that there is dense fog in an area of the road user, and that visibility may be reduced. The system may then transmit data to the road user to indicate the hazard situation and alternatively, automatically reduce the speed and/or direction of the vehicle in response to the hazard situation.

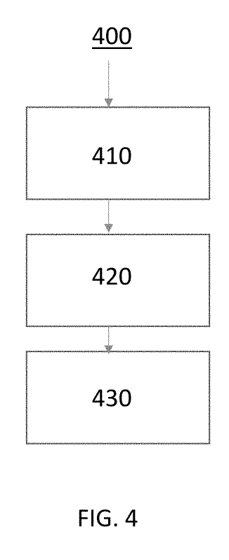

Turning now to FIG. 4, a flowchart illustrating a method 400 information processing in a system for incident avoidance for vulnerable road users according to an exemplary embodiment of the present application is shown. The first phase of the exemplary method involves each VRU determining location position and velocity and sharing the data via a network 410. The system may be operative for determining its location via integrated GPS in the mobile handheld or any other accurate method. The VRU is then operative to transmit its ID, location, speed and can also send a time stamp using V2X communication over Cellular deployment.

During the second phase of the exemplary method, a central processor, such as a central processor in a cloud network, or any central or distributed processing scheme may be used to determine VRUs in risk of a hazard situation 420. In response to the data and input from the VRUs and the vehicles, the method is then operative to identify VRUs, determine slow VRUs, such as pedestrians or skates, and fast VRUs, such as motorcyclist or cyclist. The system may be operative to constantly monitor data received from the VRUs.

Next, the system is operative to determine a hazard situation for a VRU in response to the previously received data 430. VRU in risk is identified based on monitoring VRUs data such as location, speed and time stamp, and using map data accessible by the central processor. VRUs at risk or in unexpected situations may be identified in part by determining VRUs in high mobility environments, distance and direction of the VRU relative to vehicle direction, fast changes between sidewalks and street, and unexpected locations for VRU, such as cyclists on highway, pedestrian on intercity roads. In a distributed system a warning may be activated in the vehicle systems. In a centralized system, processing and announcing the relevant vehicles on VRUs in risk and warning in the vehicle system may be effected. The system may further be operative to determine the expected paths of the vehicle or the VRU in response to kinematics, GPS, accelerometer and user inputs, if any.

In addition to transmitting warnings to the VRUs and vehicles, once a VRU at risk is identified, the system may opt to directly measure the relative positioning, range and/or direction of the specific VRU at risk. This may be done using a wireless network, such as WiFi, cellular networks, or other wireless technology. Direct monitoring may have the benefit result in facilitating the quick notification of the VRU and other users in the area of a hazard situation without having to receive transmissions from the VRU and processes those transmissions.

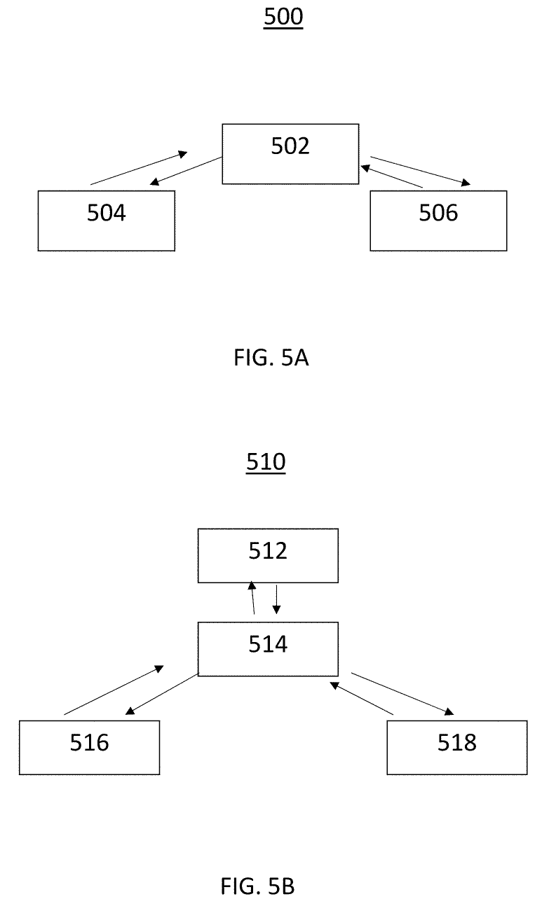

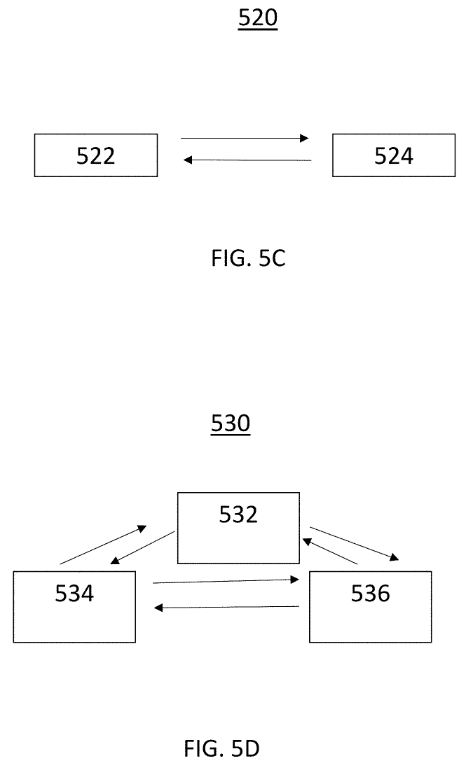

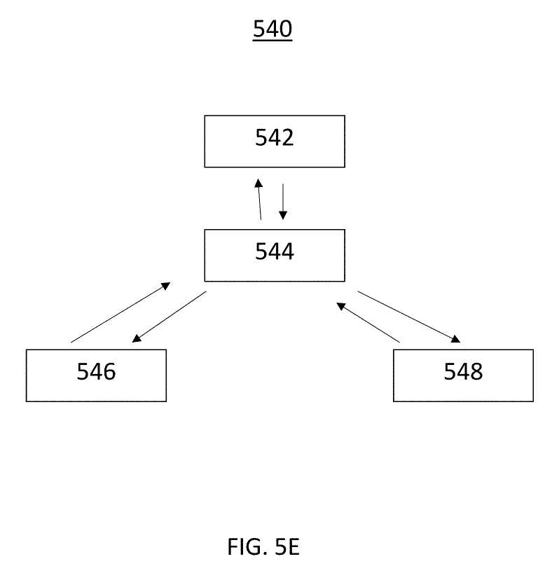

Turning now to FIG. 5A, a block diagram illustrating an exemplary implementation of an apparatus 500 according for vulnerable road user incidence avoidance is shown. The system may be a non-centralized system using infrastructure such as a base station and/or road side unit. The apparatus 500 is illustrative of communications between a vehicle 504 and a VRU 506 via a cellular base station 502, road side unit or similar network. The vehicle 504 and the VRU 506 are operative to communicate with the cellular base station 502 via DSRC or cellular communications protocol, such as 4G, mobile WiMAX, LTE, and/or IEEE 802.21.

Turning now to FIG. 5B, a block diagram illustrating an exemplary implementation of an apparatus 510 according for vulnerable road user incidence avoidance is shown. The system may be a centralized system using infrastructure such as a base unit or a road side unit. The system of apparatus 510 is illustrative of communications between a vehicle 516 and a VRU 518 via a cellular base station 514 or similar network. The vehicle 516 and the VRU 518 are operative to communicate with the cellular base station 514 via DSRC or cellular communications protocol, such as 4G, mobile WiMAX, LTE, and/or IEEE 802.21. The cellular base station 514 is coupled to a central server 512 which is operational to process data from the vehicle 516 and the VRU 518 in order to determine a hazard situation as described previously.

Turning now to FIG. 5C, a block diagram illustrating an exemplary implementation of an apparatus 520 according for vulnerable road user incidence avoidance is shown. The system may be a non-centralized scenario direct communication e.g., cellular direct communication or DSRC. The system of apparatus 520 is illustrative of communications between a vehicle 522 and a VRU 524 via non-centralized direct communications. The vehicle 522 and the VRU 524 are operative to communicate via DSRC or cellular communications protocol, such as 4G, mobile WiMAX, LTE, and/or IEEE 802.21, or any other wireless communications protocol including infrared communications.

Turning now to FIG. 5D, a block diagram illustrating an exemplary implementation of an apparatus 530 according for vulnerable road user incidence avoidance is shown. The system may be a non-centralized scenario using infrastructure and direct communication. The system of apparatus 530 is illustrative of communications between a vehicle 534 and a VRU 536 via a cellular base station 532 road side unit or similar network or network entity. The vehicle 534 and the VRU 536 are operative to communicate with the cellular base station 502 via DSRC or cellular communications protocol, such as 4G, mobile WiMAX, LTE, and/or IEEE 802.21. The vehicle 534 and the VRU 536 are operative to communicate to each other via DSRC or cellular communications protocol, such as 4G, mobile WiMAX, LTE, and/or IEEE 802.21, or any other wireless communications protocol including infrared communications, such as via DSRC or cellular direct communication (for example vehicle to pedestrian (V2P) or device-to-device (D2D) communication) or WiFi direct, or any other wireless communications protocol including infrared communications.

Turning now to FIG. 5E, a block diagram illustrating an exemplary implementation of an apparatus 540 according for vulnerable road user incidence avoidance is shown. The system may be a centralized scenario using infrastructure and direct communication. The system of apparatus 540 is illustrative of communications between a vehicle 546 and a VRU 548 via a cellular base station 544 road side unit or similar network. The vehicle 546 and the VRU 548 are operative to communicate with the cellular base station 544 via DSRC or cellular communications protocol, such as 4G, mobile WiMAX, LTE, and/or IEEE 802.21. The cellular base station 544 is coupled to a central server 542 which is operational to process data from the vehicle 546 and the VRU 548 and/or vice versa in order to determine a hazard situation as described previously. The vehicle 546 and the VRU 548 are operative to communicate to each other via DSRC or cellular communications protocol, such as 4G, mobile WiMAX, LTE, and/or IEEE 802.21, or any other wireless communications protocol including infrared communications.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links.

1. A method comprising:
receiving a first data indicating a first location and a first vector of a first road user;
receiving a second data indicating a second location and a second vector of a second road user;
determining a hazard situation in response to the first data and the second data;
transmitting a third data to said first road user in response to the hazard situation wherein said third data indicates a third vector; and
transmitting a fourth data to said second road user in response to the hazard situation wherein said fourth data indicates a fourth vector.

2. The method of claim 1 wherein said third vector and said fourth vector are generated in order to avoid the hazard situation.

3. The method of claim 1 wherein the transmitting is performed over a dedicated short range communications network.

4. The method of claim 1 further comprising receiving a fifth data wherein said fifth data is indicative of an environmental event and wherein the hazard event is further determined in response to the fifth data.

5. The method of claim 1 wherein a control data is transmitted to the second user in order to avoid the hazard situation.

6. The method of claim 1 wherein the transmitting is performed over a cellular network.

7. The method of claim 1 further comprising transmitting a sixth data indicating the hazard situation to a third user.

8. An apparatus comprising:
a receiver for receiving a first data indicating a first location and a first vector of a first road user and a second data indicating a second location and a second vector of a second road user;
a processor for determining a hazard situation in response to the first data and the second data; and
a transmitter for transmitting a third data to said first road user in response to the hazard situation wherein said third data indicates a third vector, the transmitter further operative to transmit a fourth data to said second road user in response to the hazard situation wherein said fourth data indicates a fourth vector.

9. The apparatus of claim 8 wherein said third vector and said fourth vector are generated in order to avoid the hazard situation.

10. The apparatus of claim 8 wherein the transmitting is performed over a dedicated short range communications network.

11. The apparatus of claim 8 wherein said receiver is further operative to receive a fifth data wherein said fifth data is indicative of an environmental event and wherein the hazard event is further determined in response to the fifth data.

12. The apparatus of claim 8 wherein a control data is transmitted to the second user in order to avoid the hazard situation.

13. The apparatus of claim 8 wherein the transmitting is performed over a cellular network.

14. The apparatus of claim 8 wherein the transmitter is further operative to transmit a sixth data indicating the hazard situation to a third user.

15. An vehicle comprising
a data receiver for receiving a first data indicating the location of a vulnerable road user;
a sensor for providing sensor data indicating a location and a direction of the vehicle;
a processor for determining a hazard situation in response to the sensor data the first data, the processor further operative to generate a control signal in response to the determination of the hazard situation; and
an alert system responsive to the control signal for generating an alert toward the location of the vulnerable road user.

16. The vehicle of claim 15 wherein the alert system is a directional light.

17. The vehicle of claim 15 wherein the alert system is an audible alarm.

18. The vehicle of claim 15 wherein the data receiver is a transceiver.

19. The vehicle of claim 15 wherein the first data is received from a central server.

20. The vehicle of claim 15 wherein the first data is received from a device proximate to the vulnerable road user.
